(19) United States
(12) Patent Application Publication
(10) Pub. No.: US 2006/0072847 A1
(43) Pub. Date: Apr. 6, 2006

(54) System for automatic image cropping based on image saliency

(75) Inventors: Anthony T. Chor, Bellevue, WA (US); Jordan L.K. Schwartz, Seattle, WA (US); Paul S. Hellyar, Redmond, WA (US); Tomasz S.M. Kasperkiewicz, Redmond, WA (US); David R. Parlin, Redmond, WA (US)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/956,628

(22) Filed: Oct. 1, 2004

(51) Int. Cl. G06K 9/20

(52) U.S. Cl. 382/282

(57) ABSTRACT

A computer-implemented method of automatically suggesting a cropped area of a digital image. An area of interest in an original image is determined. A design rule is applied to the area of interest to determine a suggested crop area of the original image. The suggested cropped area of the original image is presented to a user such that the suggested crop area may be resized, relocated, or accepted by the user. The cropped image may be presented to the user. Also, a computer-implemented method of automatically cropping a digital image. An area of interest in an original image is determined. A design rule is applied to the area of interest to determine a suggested crop area of the original image. The original image is cropped according to the suggested crop area. The cropped image is presented to a user or is stored. The design rule may be the Rule of Thirds or another, more sophisticated rule.

### BACKGROUND OF THE INVENTION

1. Field of the Invention

The present invention relates to image processing. More specifically, the present invention relates to automatic image cropping based on an area of interest and a design rule.

2. Description of the Related Art

Image cropping is a feature of many image processing applications. When a user wants to crop an image, the user generally selects a crop command and some indication of the area to be cropped from the original image appears on the original image, e.g., a dashed line bordering the area to be cropped. The user then resizes or relocates the area to be cropped and indicates his acceptance of the area to be cropped. The original image is then cropped accordingly.

In order to accomplish a successful crop, i.e., one that is acceptable to the user, the user must always specify the area to be cropped. In other words, in the prior art there is no machine intelligence that helps the user select a better crop region. As a result, the user often has to manually determine the area of interest in the original image and manually apply design rules in order to produce a visually pleasing cropped image. Design rules are used by photographers and people editing photographs to produce pleasing and balanced images. One example of a design rule is the Rule of Thirds, which provides that the area of interest in a picture should be placed at an intersection of two of the lines dividing the picture into thirds, or for longer areas of interest, along one of the lines dividing the thirds. In another example, if there is a subject in motion in the frame, then the photographer/editor should generally leave more room in the photo for the subject to “move into” (e.g., if the photo contains dog running to the right, that dog should not be placed against the right-most edge of the frame; it should be placed more to the left). In a further example, a similar rule applies to people that aren't looking straight at the camera. If a person is looking to the right, they should not be placed near the right edge of the frame (they need “space” to look into).

If the area to be cropped is carelessly applied, the true area of interest, e.g., a smiling child, may get cropped in favor of a meaningless item in the surrounding area, e.g., a wall. Therefore, the user must always specify the area to be cropped to ensure that the cropped image reflects the desired cropped area. As a result, an image processing application is needed that automatically and intelligently suggests an area to be cropped, taking into consideration the area of interest of the image and a design rule.

### SUMMARY OF THE INVENTION

The present invention provides a computer-implemented method of and a machine-readable medium for automatically suggesting a cropped area of a digital image. An area of interest in an original image is determined. A design rule is applied to the area of interest to determine a suggested crop area of the original image. The suggested cropped area of the original image is presented to a user such that the suggested crop area may be resized, relocated, or accepted by the user. The design rule may be the Rule of Thirds or another, more sophisticated rule. The cropped image may be presented to the user.

The present invention also provides a computer-implemented method of and a machine-readable medium for automatically cropping a digital image. An area of interest in an original image is determined. A design rule is applied to the area of interest to determine a suggested crop area of the original image. The original image is cropped according to the suggested crop area. The cropped image is presented to a user or is stored. The design rule may be the Rule of Thirds or another, more sophisticated rule.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 illustrates a flowchart of the automatic cropping of an image, according to embodiments of the present invention; and

FIGS. 3a-c illustrate an example image that is automatically cropped, according to embodiments of the present invention.

### DETAILED DESCRIPTION OF THE INVENTION

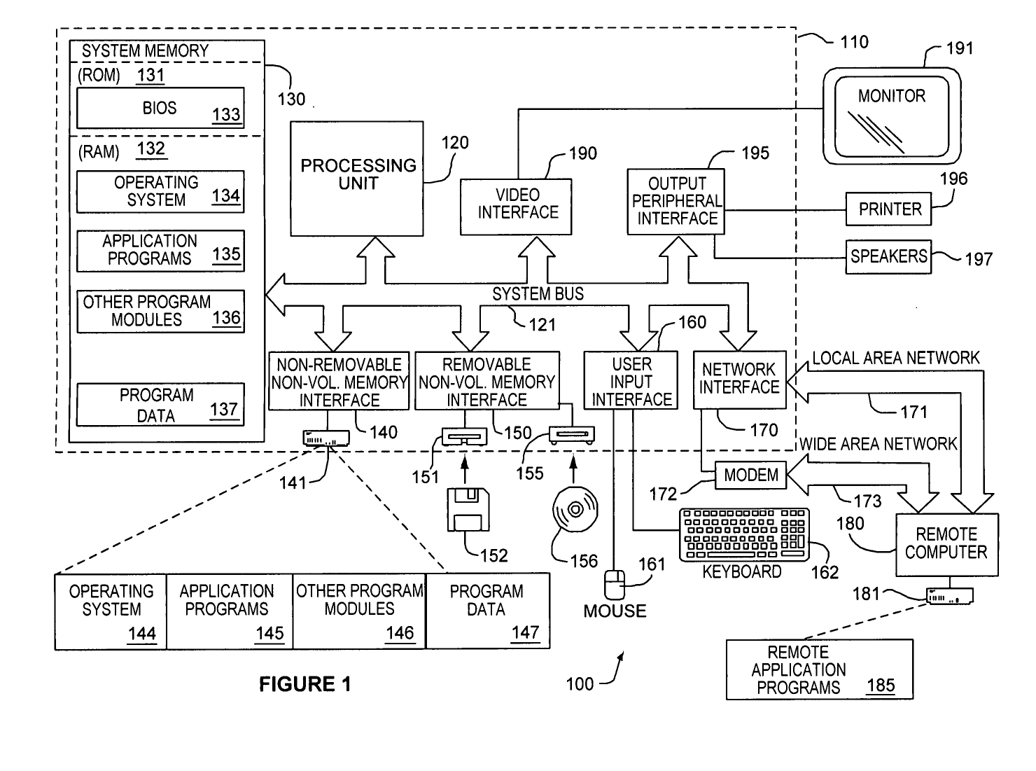

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Interconnect (PCI) bus also know as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable medial may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently begin operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drive and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different number here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, camera, camera-equipped phone, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user network interface 170, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

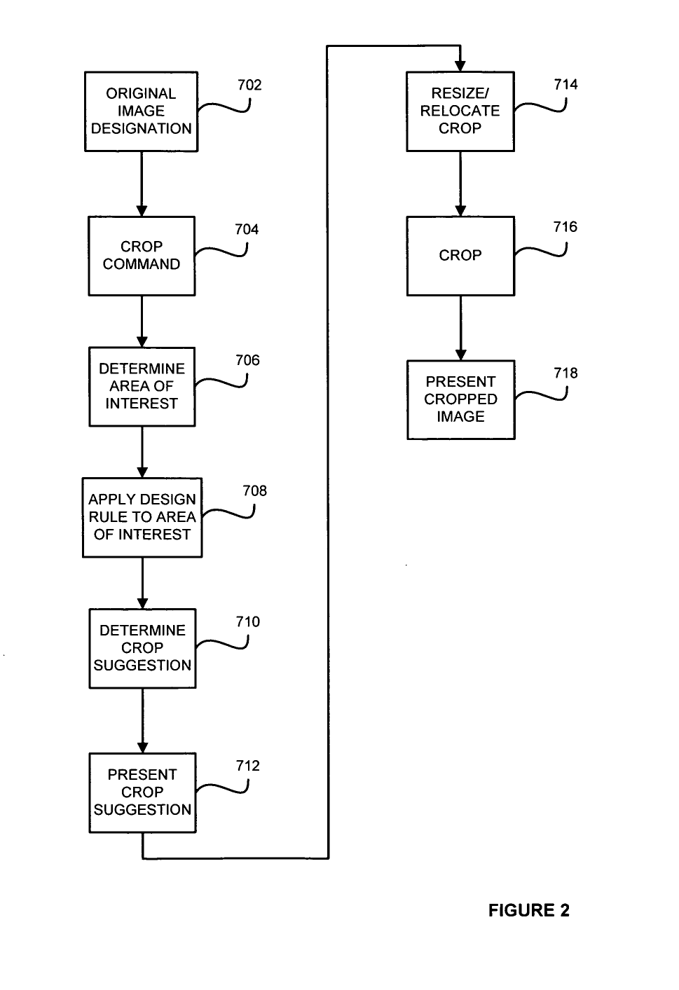

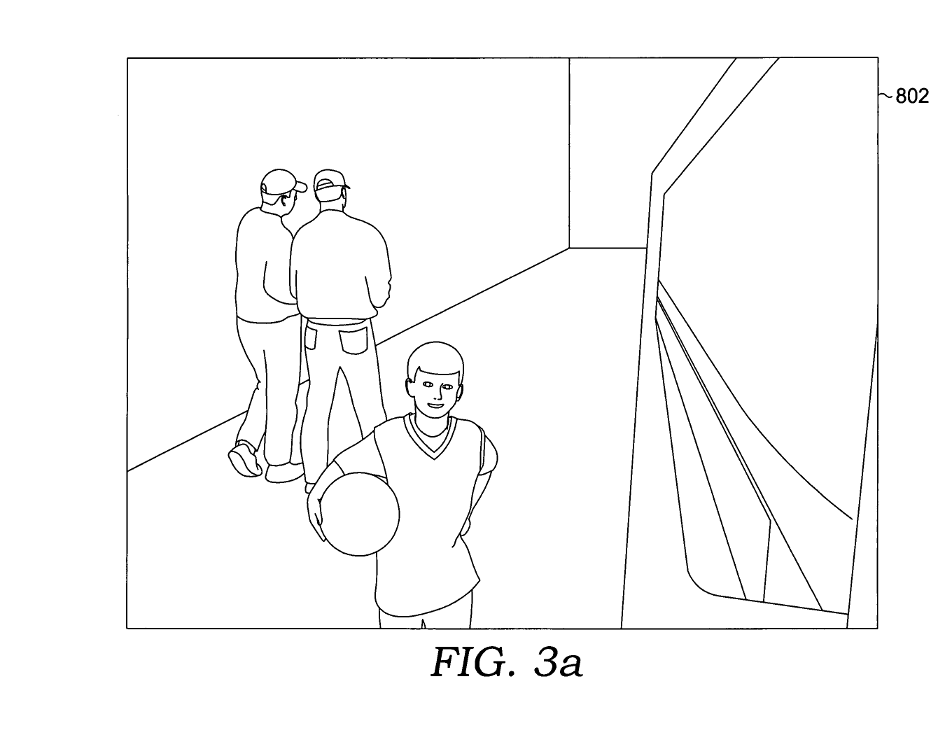

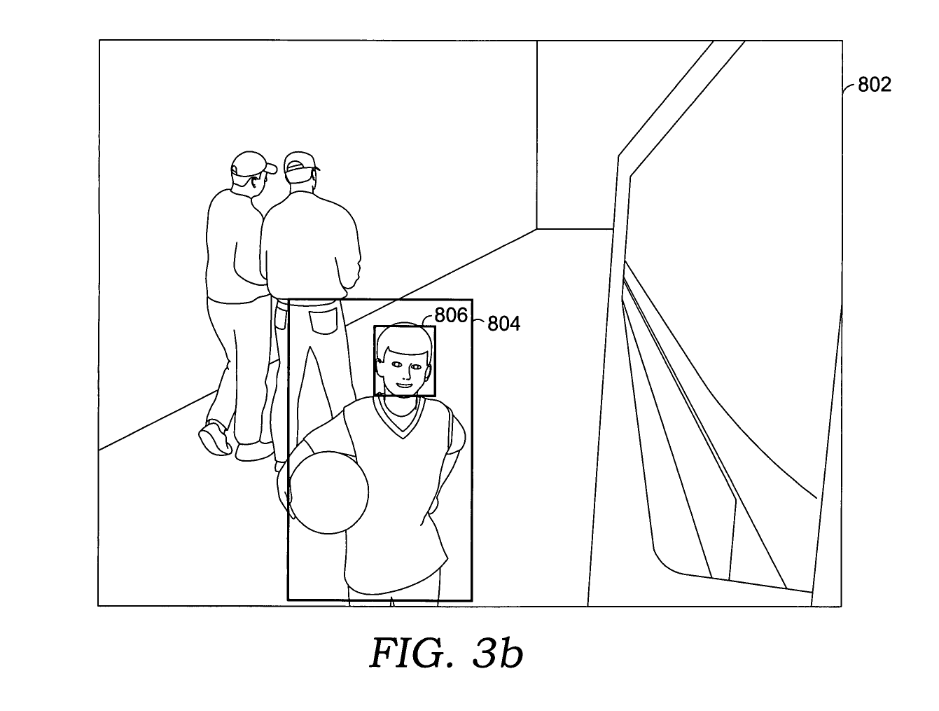

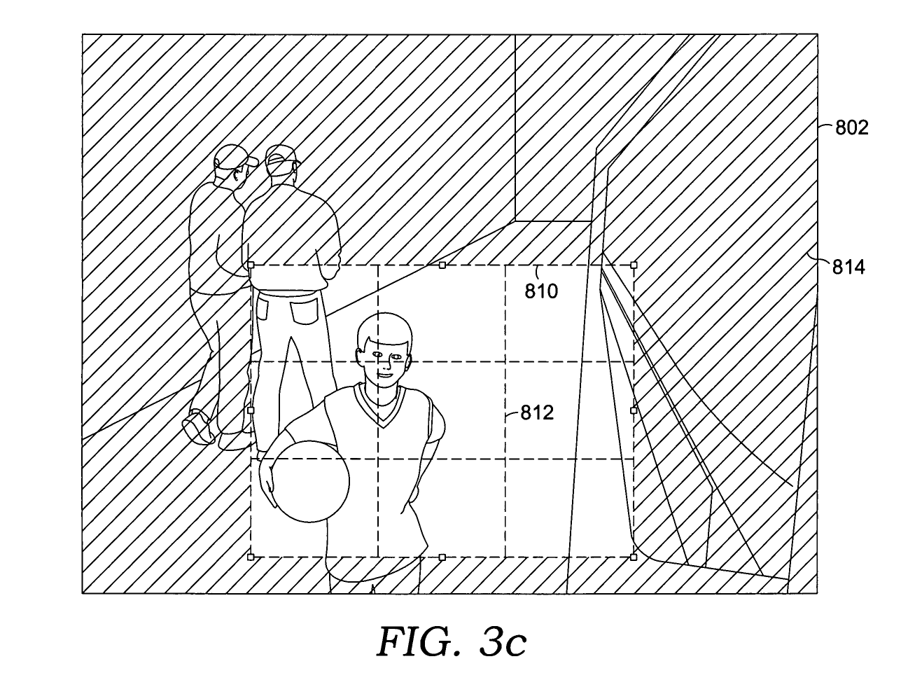

FIG. 2 illustrates a flowchart of the automatic cropping of an image, according to embodiments of the present invention. With reference to FIG. 2, in an embodiment, a designation of an original image is received from a user (702). For example, the user may designate the original image, which is stored on the user's hard drive, using an image editing application. In another example, the user may designate the original image, which is stored on the user's camera, using a built-in application on the camera. However, embodiments of the present invention are not limited to the examples provided, as any original image designation method may be performed. In addition, embodiments of the present invention are not limited to a user designating the original image. For example, in another embodiment, the designation is done automatically (e.g., by a screen saver application), either randomly or via an algorithm. In a screen saver application, image designation and cropping may be performed automatically, without user input. For example, one of the purposes of a screen saver may be to display random intelligently cropped images when a user is not active. If the user is not active, they will be unable or unwilling to designate each image (and accept or edit the suggested crop area, as discussed below). See the discussion of FIG. 3a (below) for an example of the designated image.

After the original image is designated, in an embodiment, a crop command is received (704). In an embodiment, the user initiates the crop command from the image editing application by selecting a control button in the user interface. However, embodiments of the present invention are not so limited. For example, in another embodiment, the user initiates the crop command from a built-in application in the camera. In another example, in another embodiment, the crop command is initiated automatically.

After the crop command is received, in an embodiment, an area of interest of the designated image is determined (706). In an embodiment, the area of interest is determined using the method discussed in U.S. application Ser. No. 10/676,519, entitled “A Contrast-Based Image Attention Analysis Framework”, by Yu-Fei Ma and Hong-Jiang Zhang, which was filed on Sep. 30, 2003. However, embodiments of the present invention are not so limited, as any other method of determining the area of interest may be used. See the discussion of FIG. 3b (below) for an example of the designation of the area of interest.

After the area of interest is determined, in an embodiment, a design rule is applied to the area of interest (708). In an embodiment, the Rule of Thirds, which is well known in the art, is the design rule. However, embodiments of the present invention are not so limited. In an embodiment, for example, any other well known design rules may be used, such as leaving room in the frame for moving subjects to “move into.” In another embodiment, for example, multiple design rules may be applied. In a further embodiment, multiple design rules are presented to the user for selection. See the discussion of FIG. 3c (below) for an example of the application of the design rule.

After the design rule is applied, in an embodiment, a suggested crop area is determined (710). In an embodiment, the crop area is a smaller area than the area of the designated image, and the height and width dimensions maintain the same ratio as the designated image. For example, in an embodiment, the designated image is 1600 pixels by 1200 pixels, and the suggested crop area is 800 pixels by 600 pixels. However, embodiments of the present invention are not so limited, as the dimensions of the suggested crop area may have any ratio, and may be measured in any manner. For example, in another embodiment, the designated image is eight inches by twelve inches, and the suggested crop area is six inches by six inches. Although embodiments discussed below detail several instances when the suggested crop area will not be presented to the user, the use of the term “suggested” crop area is intended to maintain consistency and is not intended to impart any limitation thereon.

After the suggested crop area is determined, in an embodiment, the suggested crop area is presented to the user (712). In an embodiment, the suggested crop area is presented to the user by outlining the suggested crop area in a dashed line and obscuring, such as by shading out, the remainder of the designated image. However, embodiments of the present invention are not so limited to any specific method of presentation. In another example, in an embodiment, the suggested crop area is outlined in a solid line. In yet another example, the suggested crop area is presented apart from the designated image. In another example, the suggested crop area is presented concurrently with the original image, e.g., side-by-side, above/below, overlapping windows, etc. Embodiments of the present invention are not limited to the application and presentation of a single suggested crop area. For example, multiple design rules may be used to suggest and present multiple suggested crop areas from which the user can choose. In an embodiment, the suggested crop area is presented to the user on a display of a computing device. In another embodiment, the suggested crop area is presented to the user on the display of a camera. However, embodiments of the present invention are not limited to any particular means of presentation. Also, presentation of the suggested crop area to the user is optional. For example, in an embodiment (e.g., in a screen saver application), the suggested crop area is not presented to the user. See FIG. 3c (below) for an example of the presentation of the suggested crop area.

If the suggested crop area is presented to the user, in an embodiment, the user is given the opportunity to accept the suggested crop area or resize or relocate the suggested crop area to encompass a different portion of the designated image (714). The resizing and relocating of suggested crop area is well known in the art, and in an embodiment, is accomplished by the user dragging and dropping the suggested crop area (relocate) or dragging the border of the suggested crop area (resize). However, embodiments of the present invention are not limited to any particular method of resizing or relocating the suggested crop area. For example, in another embodiment, the user may input the desired size or location of the suggested crop area. Also, allowing the user to resize or relocate the suggested crop area is optional. For example, in an embodiment (e.g., in a screen saver application), the suggested crop area is not able to be resized or relocated by the user. Further, in an embodiment, the user may choose to accept the suggested crop area as-is without any resizing or relocating. In an embodiment, the result of any resizing or relocating of the suggested crop area is visible to the user for acceptance or further resizing or relocating.

After the suggested crop area is determined, after the suggested crop area is accepted (if applicable), and after any resizing or relocating (if applicable), the designated image is cropped according to the suggested crop area or the relocated or resized suggested crop area (716). The cropping of an image according to a suggested crop area or a relocated or resized suggested crop area is well known in the art. In an embodiment, the cropped image is stored separately from the designated image. In an embodiment, the cropped image is stored in RAM, ROM, or other forms of permanent, volatile, or nonvolatile memory.

After the designated image is cropped, the cropped image is presented to the user (718). In an embodiment, the cropped image is presented to the user on a display of a computing device. In another embodiment, the cropped image is presented to the user on the display of a camera. However, embodiments of the present invention are not limited to any particular means of presentation. For example, in an embodiment, the cropped image is presented to the user by printing the cropped image. Also, presentation of the cropped image to the user is optional. For example, in an embodiment, the user accepts, resizes, or relocates the suggested crop area and the cropped image is stored without presentation to the user.

FIGS. 3a-c illustrate an example image that is automatically cropped, according to embodiments of the present invention. With reference to FIG. 3a, original image 802 is illustrated. In original image 802, a small child is standing and holding a ball near a wall in the foreground, and two adults are walking away in the background. With reference to FIG. 3b, two areas of interest are illustrated: area of interest 804 encompassing the entire child, and area of interest 806 encompassing just the child's head. With reference to FIG. 3c, design rule 812 (in FIG. 3c, the Rule of Thirds is illustrated) is used to determine suggested crop area 810, while the remainder of original image 802 is illustrated with shading 814.

In an embodiment, when applying design rule 812 to either area of interest 804 or 806, the goal is to place the area of interest over the intersection of the lines dividing the suggested crop area into thirds. FIG. 3c is drawn to illustrate the same suggested crop area 810 for either area of interest 804 or 806, but embodiments of the present invention may create different suggested crop areas depending on the particular area of interest. If area of interest 804 (long and narrow) is used, then design rule 812 is applied such that the leftmost vertical line runs vertically through area of interest 804, roughly in the center thereof. If area of interest 806 (smaller and square) is used, then design rule 812 is applied such that the leftmost vertical and topmost horizontal lines intersect inside area of interest 806, roughly in the center thereof. Depending on characteristics of the area of interest, e.g., a person is facing left or right, any of the lines may be used. Embodiments of the present invention are not limited to any particular original image 802. In addition, embodiments of the present invention are not limited to any particular areas of interest 804 and 806 (or number thereof). Further, embodiments of the present invention area not limited to any particular suggested crop area 810 (or size or orientation thereof). Embodiments of the present invention are not limited to any particular design rule 812 (or application thereof). Lastly, embodiments of the present invention are not limited to any particular shading 814 (or presence or absence thereof).

Together with the determination of the area of interest and the application of the design rule, the determination of the suggested crop area differs from the previous suggestion of crop areas in the art. Previously, as discussed above, the suggestion of a crop area is “dumb,” i.e., the crop area suggestion is presented with the assumption that the user will resize or relocate the crop area as desired. In the present invention, the use of the area of interest determination and the design rule to determine the suggested crop area yields a suggested crop area that is much more likely to be immediately accepted by or pleasing to a user without the need to resize or relocate. As discussed above, previously, the user would have to resize or relocate the suggested crop area almost all of the time, whereas with the present invention, the user will accept or approve of the suggested crop area most of the time. In an embodiment where the cropping is done automatically without first presenting a suggestion to the user, the automatically cropped image will be much more likely to be pleasing to the user. The determination of the area of interest, the application of the design rule, and the determination of the suggested crop area is transparent to the user. Often, the user will simply be pleased that the suggested crop area is very similar what he would have created on his own.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The invention claimed is:

1. A computer-implemented method of automatically suggesting a cropped area of a digital image, comprising:
determining an area of interest in an original image;
applying a design rule to the area of interest to determine a suggested crop area of the original image; and
presenting the suggested cropped area of the original image to a user such that the suggested crop area may be resized, relocated, or accepted by the user.

2. The method of claim 1, wherein the design rule is the Rule of Thirds.

3. The method of claim 1, further comprising:
receiving a designation of the original image from the user.

4. The method of claim 3, further comprising:
receiving a command from the user to crop the original image.

5. The method of claim 1, further comprising:
cropping the original image according to the suggested crop area.

6. The method of claim 5, further comprising:
storing the cropped image.

7. The method of claim 5, further comprising:
presenting the cropped image to the user.

8. The method of claim 1, further comprising:
resizing or relocating the suggested crop area according to an input from the user.

9. The method of claim 8, further comprising:
cropping the original image according to the relocated or resized suggested crop area.

10. The method of claim 9, further comprising:
presenting the cropped image to the user.

11. A machine-readable medium that provides instructions for automatically suggesting a cropped area of a digital image, which, when executed by a machine, cause the machine to perform operations comprising:
determining an area of interest in an original image;
applying a design rule to the area of interest to determine a suggested crop area of the original image; and
presenting the suggested cropped area of the original image to a user such that the suggested crop area may be resized, relocated, or accepted by the user.

12. The machine-readable medium of claim 11, wherein the design rule is the Rule of Thirds.

13. The machine-readable medium of claim 11, wherein the instructions cause the machine to perform operations further comprising:
receiving a designation of the original image from the user.

14. The machine-readable medium of claim 13, wherein the instructions cause the machine to perform operations further comprising:
receiving a command from the user to crop the original image.

15. The machine-readable medium of claim 11, wherein the instructions cause the machine to perform operations further comprising:
cropping the original image according to the suggested crop area.

16. The machine-readable medium of claim 15, wherein the instructions cause the machine to perform operations further comprising:
storing the cropped image.

17. The machine-readable medium of claim 15, wherein the instructions cause the machine to perform operations further comprising:
presenting the cropped image to the user.

18. The machine-readable medium of claim 11, wherein the instructions cause the machine to perform operations further comprising:
resizing or relocating the suggested crop area according to an input from the user.

19. The machine-readable medium of claim 18, wherein the instructions cause the machine to perform operations further comprising:
cropping the original image according to the relocated or resized suggested crop area.

20. The machine-readable medium of claim 19, wherein the instructions cause the machine to perform operations further comprising:
presenting the cropped image to the user.

21. A computer-implemented method of automatically cropping a digital image, comprising:
determining an area of interest in an original image;
applying a design rule to the area of interest to determine a suggested crop area of the original image;
cropping the original image according to the suggested crop area; and
presenting the cropped image to a user or storing the cropped image.

22. The method of claim 21, wherein the design rule is the Rule of Thirds.

23. The method of claim 21, further comprising:
automatically designating the original image to be cropped.

24. A machine-readable medium that provides instructions for automatically cropping a digital image, which, when executed by a machine, cause the machine to perform operations comprising:
determining an area of interest in an original image;
applying a design rule to the area of interest to determine a suggested crop area of the original image;
cropping the original image according to the suggested crop area; and
presenting the cropped image to a user or storing the cropped image.

25. The machine-readable medium of claim 24, wherein the design rule is the Rule of Thirds.

26. The machine-readable medium of claim 24, wherein the instructions cause the machine to perform operations further comprising:
automatically designating the original image to be cropped.
